(19) United States
(12) Patent Application Publication
(10) Pub. No.: US 2015/0205719 A1
(43) Pub. Date: Jul. 23, 2015

(54) Memory Control Circuit

(71) Applicant: Rohm Co., Ltd., Kyoto (JP)

(72) Inventors: Takashi Murakami, Tokyo (JP); Shinya Masuda, Kyoto (JP)

(21) Appl. No.: 14/597,490

(22) Filed: Jan. 15, 2015

(30) Foreign Application Priority Data
Jan. 21, 2014 (JP) 2014-008760

(51) Int. Cl. G06F 12/02

(52) U.S. Cl. CPC G06F 12/0246; G06F 2212/7201

(57) ABSTRACT

A memory control circuit includes an address conversion unit configured to perform an address conversion between a central processing unit (CPU) and a non-volatile memory such that the CPU recognizes that a program to be executed by the CPU is stored in a first address region of the non-volatile memory irrespective of whether the program is stored in the first address region or a second address region of the non-volatile memory.

### CROSS-REFERENCE TO RELATED APPLICATIONS

This application is based upon and claims the benefit of priority from Japan Patent Applications No. 2014-008760, filed on Jan. 21, 2014, the entire contents of which are incorporated herein by reference.

### TECHNICAL FIELD

The present disclosure relates to a memory control circuit.

### BACKGROUND

FIG. 7 is a block diagram illustrating an example of a conventional electronic device. The conventional electronic device X comprises a central processing unit (CPU) X1, a flash controller X2, and a flash memory X3. In order to execute a program (firmware, etc.) stored in the flash memory X3 by the CPU X1, the flash controller X2 that performs access control on the flash memory X3 according to an instruction from the CPU X1 is required.

Recently, a program stored in the flash memory X3 may be generally rewritten as needed even after mass-production of the electronic device X. In order to safely update this program (updating firmware, etc.), two or more address regions (program storage regions) for storing the program need to be prepared.

For example, in a state where firmware PRG1 of a current version is stored in a first address region X31, when updating with firmware PRG2 of a new version is to be performed, the first address region X31 is not overwritten but the firmware PRG2 of the new version may be written to a second address region X32. After confirming that the writing has been successfully completed, the firmware PRG2 of the new version may be read from the second address region X32 and executed. By using this processing, since the firmware PRG1 of the current version is not overwritten and remains in the first address region X31, operation of the electronic device X is not disrupted even when the process of updating the firmware is interrupted.

However, when a storage address of a program is changed, a compile environment for creating a binary file from a source file also needs to be changed, which thereby causes complications.

FIG. 8 is a diagram illustrating an example of a conventional compiling process. In this conventional compiling process, if a storage destination of a new program is the first address region X31, a binary file for storing the first address region needs to be created by delivering the starting address (0x1000) to a compiler, and if a storage destination of a new program is the second address region X32, a binary file for storing a second address region needs to be created by delivering the starting address (0x3000) of the corresponding region to a compiler.

For example, if a server performs the compiling process for updating the firmware, the server does not know whether the new version of the firmware should be written in the first address region X31 or the second address region X32, and thus, the electronic device X needs to inform the storage destination of the new program to the server.

### SUMMARY

The present disclosure provides some embodiments of a memory control circuit where a compile environment does not need to be changed even when a storage destination of a program is changed.

According to one embodiment of the present disclosure, provided is a memory control circuit, including: an address conversion unit configured to perform an address conversion between a central processing unit (CPU) and a non-volatile memory such that the CPU recognizes that a program to be executed by the CPU is stored in a first address region of the non-volatile memory irrespective of whether the program is stored in the first address region or a second address region of the non-volatile memory (first embodiment).

Further, the memory control circuit having the first configuration further includes a register unit configured to store register values, wherein the address conversion unit is configured to determine whether to perform an address conversion based on the register values (second embodiment).

Also, in the memory control circuit having the second configuration, the register unit is configured to store, as the register values, a first register value for setting a starting address of the first address region, and a second register value for setting a size of a program stored in the first address region or a starting address of the second address regions (third embodiment).

Also, in the memory control circuit having the second or third configuration, when the CPU accesses the first address region, the address conversion unit reads the program stored in the first address region without performing an address conversion if the register values have not been set, and the address conversion unit performs an address conversion to read the program stored in the second address region if the register values have been completely set (fourth embodiment).

According to another embodiment of the present disclosure, provided is a semiconductor device, including: a CPU; and the memory control circuit having any one of the first to fourth configurations, configured to control access to a non-volatile memory based on an instruction from the CPU, wherein the CPU and the memory control circuit are integrated (fifth embodiment).

Also, in the semiconductor device having the fifth configuration, when a current program stored in the non-volatile memory is updated with a new program, the CPU stores the new program in the second address region if the current program is stored in the first address region, and the CPU stores the new program in the first address region if the current program is stored in the second address region (sixth embodiment).

Also, in the semiconductor device having the sixth configuration, after storing the new program, the CPU updates the register values based on a storage destination of the new program (seventh embodiment).

Also, the semiconductor device having any one of the fifth to seventh configurations further includes: a volatile memory configured to be used as an operation region of the CPU or a temporary storage region of various data; a digital signal processing circuit configured to process a digital signal based on an instruction from the CPU; a digital-to-analog (DA) conversion circuit configured to convert the digital signal input from the digital signal processing circuit into an analog signal and output the analog signal to an external device; and an analog-to-digital (AD) conversion circuit configured to convert an analog signal input from the external device into a digital signal and output the digital signal to the digital signal processing circuit, wherein the volatile memory, the digital signal processing circuit, the DA conversion circuit, and the AD conversion circuit are integrated (eighth embodiment).

According to another embodiment of the present disclosure, provided is a power line communication device, including: the semiconductor device having the eighth configuration; a non-volatile memory configured to be access-controlled by the semiconductor device; and a transformer configured to insulate between the semiconductor device and a power line and deliver analog signals (ninth configuration).

Also, in the power line communication device having the ninth configuration, the non-volatile memory is a serial flash memory (tenth embodiment).

### BRIEF DESCRIPTION OF THE DRAWINGS

FIG. 1 is a diagram illustrating an in-house LAN system according to an embodiment of the present disclosure.

FIG. 2 is a block diagram illustrating an HD-PLC adapter according to an embodiment of the present disclosure.

FIG. 3 is a block diagram illustrating a flash controller according to an embodiment of the present disclosure.

FIG. 4 is a diagram illustrating an address conversion process according to an embodiment of the present disclosure.

FIG. 5 is a diagram illustrating a compiling process according to an embodiment of the present disclosure.

FIG. 6 is a flow chart illustrating a firmware updating process according to an embodiment of the present disclosure.

FIG. 7 is a block diagram illustrating a conventional electronic device.

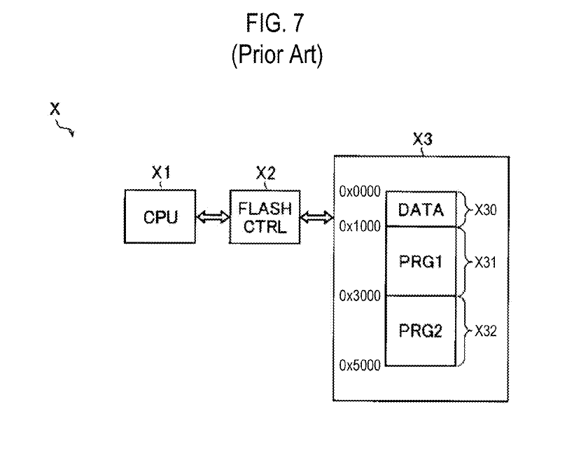

FIG. 8 is a view illustrating a conventional compiling process.

### DETAILED DESCRIPTION

An embodiment of the present disclosure will now be described in detail with reference to the drawings.

### In-house LAN (Local Area Network) System

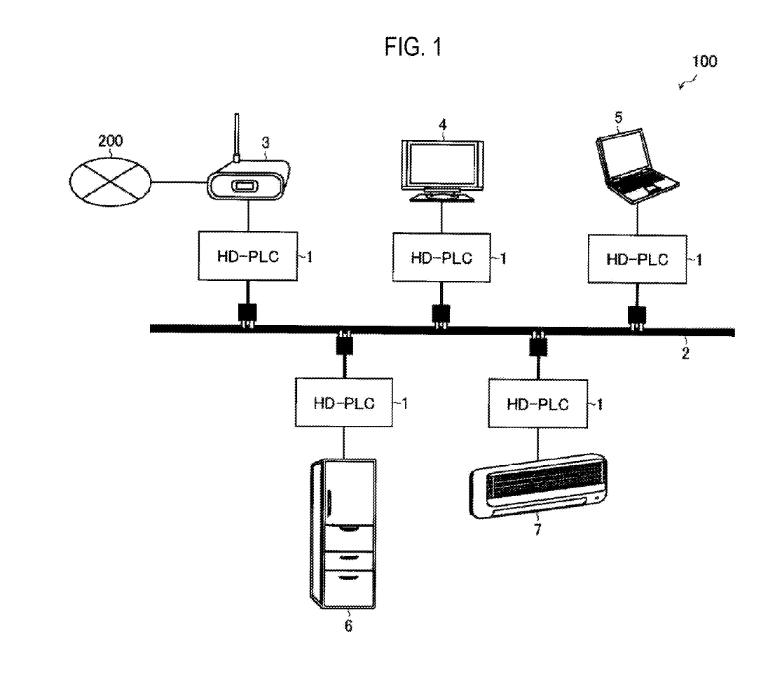

FIG. 1 is a diagram illustrating an in-house LAN system 100 according to an embodiment of the present disclosure. The in-house LAN system 100 comprises a plurality of high definition-power line communication (HD-PLC) adapters 1, a power line 2, a router 3, a television (TV) 4, a personal computer (PC) 5, a refrigerator 6, and an air-conditioner 7.

The plurality of HD-PLC adapters 1 are power line communication devices (modems having a bridge function) for modulating an information signal (image signal, voice signal, etc.) according to a wavelet-orthogonal frequency-division multiplexing (OFDM) scheme and superposing the modulated signal onto the power line 2 to realize two-way communication between terminals connected thereto. For example, in the case of accessing the Internet 200 (accessing a website, etc.) using the PC 5, two-way communication is performed through the power line 2 between the HD-PLC adapter 1 (e.g., a parent device) connected to the router 3 and the HD-PLC adapter 1 (e.g., a child device) connected to the PC 5.

In this manner, in the in-house LAN system 100 using HD-PLC adapters 1, the power line 2 pre-installed in the house may be used as a communication line. Further, when the HD-PLC adapters 1 are configured as multiport type adapters, a plurality of terminals may be connected to a single HD-PLC adapter 1. In addition, the types of terminals that configure the in-house LAN system 100 are not limited to this embodiment (the router 3, the TV 4, the PC 5, the refrigerator 6, and the air-conditioner 7), and various terminals may be connected.

### HD-PLC Adapter

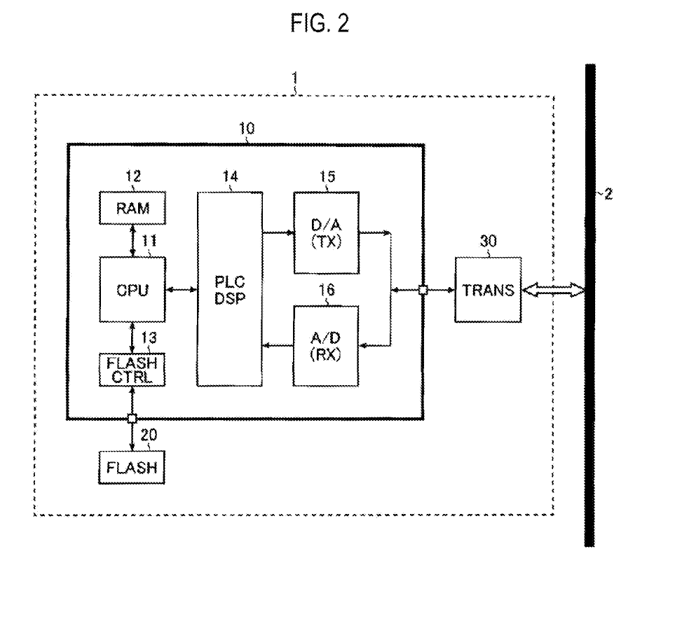

FIG. 2 is a block diagram illustrating an HD-PLC adapter 1 according to an embodiment of the present disclosure. The HD-PLC adapter 1 comprises a semiconductor device 10, a flash memory 20, and a transformer 30. In addition, power is supplied from the power line 2 to the HD-PLC adapter 1.

The semiconductor device 10 is a controller IC for controlling power line communication through the transformer 30, and comprises a central processing unit (CPU) 11, a random access memory (RAM) 12, a flash controller 13, a PLC digital signal processor (DSP) 14, a digital-to-analog (DA) conversion circuit 15, and an analog-to-digital (AD) conversion circuit 16, which are integrated.

The CPU 11 controls the overall operation of the semiconductor device 10. For example, the CPU 11 controls communication with a terminal (not shown) connected to the HD-PLC adapter 1, and the like, in addition to controlling operations of the PLC DSP 14 and the flash controller 13.

The RAM 12 is a volatile semiconductor memory used as an operation region of the CPU 11 and a temporary storage region of various data.

The flash controller 13 is a memory control circuit that performs access control to the flash memory 20 according to an instruction from the CPU 11.

The PLC DSP 14 is a digital signal processing circuit that processes a digital signal according to an instruction from the CPU 11.

The DA conversion circuit 15 is a circuit block that converts a digital signal input from the PLC DSP 14 into an analog signal and outputs the converted analog signal to the transformer 30, and serves as a transmission circuit TX of the HD-PLC adapter 1.

The AD conversion circuit 16 is a circuit block that converts an analog signal input from the transformer 30 into a digital signal and outputs the converted digital signal to the PLC DSP 14, and serves as a reception circuit RX of the HD-PLC adapter 1.

The flash memory 20 is a non-volatile semiconductor memory that stores firmware of the HD-PLC adapter 1 and the like. A serial flash memory employing a serial bus may be used as the flash memory 20.

The transformer 30 insulates between the semiconductor device 10 and the power line 2, and delivers analog signals. In addition, the transformer 30 may include a coupling capacitor for blocking alternating current frequency components (50 Hz/60 Hz) of commercial power.

Further, the semiconductor device 10, the flash memory 20, and the transformer 30 mentioned above may be installed as a single communication module in the HD-PLC adapter 1.

### Flash Controller

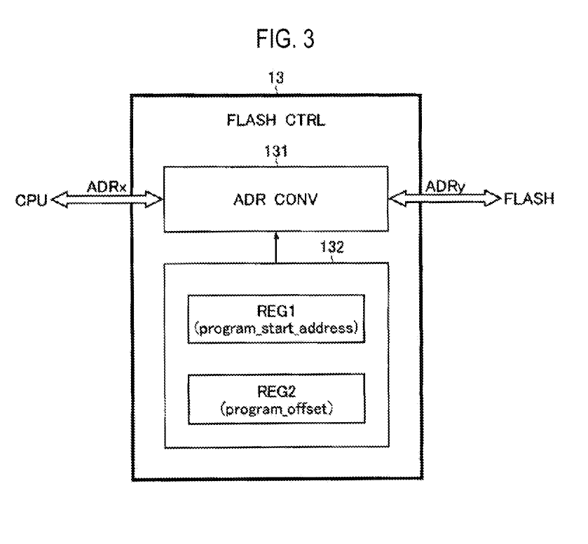

FIG. 3 is a block diagram illustrating a flash controller 13 according to an embodiment of the present disclosure. The flash controller 13 comprises an address conversion unit 131 and a register unit 132.

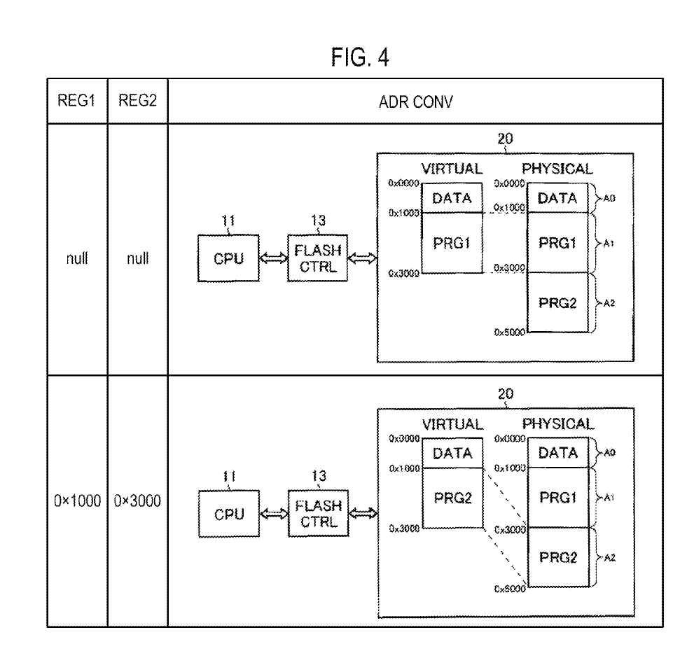

The address conversion unit 131 performs an address conversion (ADRx/ADRy) between the CPU 11 and the flash memory 20 so that the CPU 11 recognizes that a program to be executed by the CPU 11 is stored in a first address region A1 for both cases where the program is stored in the first address region A1 and in a second address region A2 (shown in FIG. 4) of the flash memory 20. At this time, the address conversion unit 131 determines whether to perform an address conversion based on a first register value REG1 and a second register value REG2 stored in the register unit 132. Details thereof will be described later.

The register unit 132 stores the first register value REG1 (program_start_address) for setting a starting address of the first address region A1 and the second register value REG2 (program_offset) for setting a size of a program stored in the first address region A1 or a starting address of the second address region A2.

FIG. 4 is a diagram illustrating an address conversion process by the flash controller 13 according to an embodiment of the present disclosure. In the following description, in a physical address map (PHYSICAL) of the flash memory 20, it is assumed that various data (DATA) is stored in an address region A0 (0x0000-0x1000) and programs PRG1 and PRG2 are stored in a first address region A1 (0x1000-0x3000) and a second address region A2 (0x3000-0x5000), respectively.

Meanwhile, in a virtual address map (VIRTUAL) of the flash memory 20 viewed from the CPU 11, it is recognized that various data (DATA) is stored in an address region A0 (0x0000-0x1000) and one of the programs PRG1 and PRG2 is stored in a first address region A1 (0x1000-0x3000). Hereinafter, the reason will be described in detail.

First, a case in which both the first register value REG1 and the second register value REG2 have not been set (REG1=null, REG2=null) will be described in detail with reference to the upper portion of FIG. 4. When the CPU 11 accesses the first address region A1 of the flash memory 20, if both the first register value REG1 and the second register value REG2 have not been set, the address conversion unit 131 of the flash controller 13 reads the program PRG1 stored in the first address region A1 without performing an address conversion. As a result, the CPU 11 may access the first address region A1 to read the program PRG1 and execute the program PRG1.

Next, a case in which both the first register value REG1 and the second register value REG2 have been completely set (REG1=0x1000, REG2=0x3000) will be described in detail with reference to the lower portion of FIG. 4. When the CPU 11 accesses the first address region A1 of the flash memory 20, if both the first register value REG1 and the second register value REG2 have been completely set, the address conversion unit 131 of the flash controller 13 performs an address conversion to thereby read the program PRG2 stored in the second address region A2. As a result, the CPU 11 may access the first address region A1 to read the program PRG2 and execute the program PRG2.

That is, when the program PRG1 stored in the first address region A1 is to be executed, both the first register value REG1 and the second register value REG2 should not be set. On the other hand, when the program PRG2 stored in the second address region A2 is to be executed, the first register value REG1 and the second register value REG2 should be each appropriately set.

By performing an address conversion process based on the first register value REG1 and the second register value REG2 using the flash controller 13, the program to be executed by the CPU 11 is considered as being stored in the first address region A1 at all times.

That is, in an external virtual address map recognized by the CPU 11, a storage destination of a program to be executed by the CPU 11 can be fixed to the first address region A1 and, further, a compile environment of a program can be set to remain unchanged regardless of a storage destination of a program in the physical address map. This will be described in detail below.

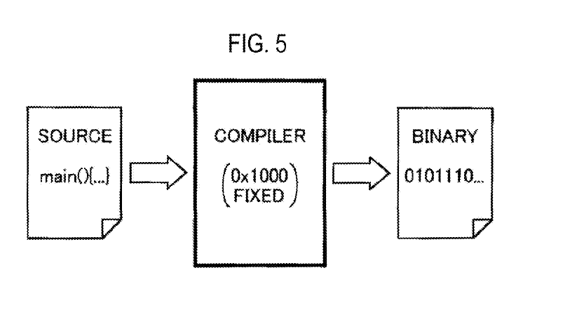

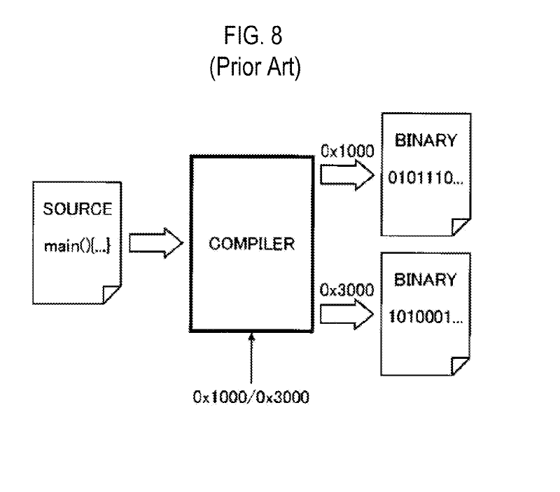

FIG. 5 is a diagram illustrating a compiling process according to an embodiment of the present disclosure. In the conventional compiling processing (see FIG. 8), when a storage destination address of a program is changed, a compile environment for creating a binary field from a source file needs to be changed, which thereby causes complications. Meanwhile, when the foregoing address conversion process is performed, a storage destination of a program is fixed to the first address region A1 when seen from the outside. Thus, a compiler may simply create a binary file for storing a first address region from the source file of the program, and thus, the compiler can create a binary file in a common compile environment without the need of recognizing a storage destination address of the program.

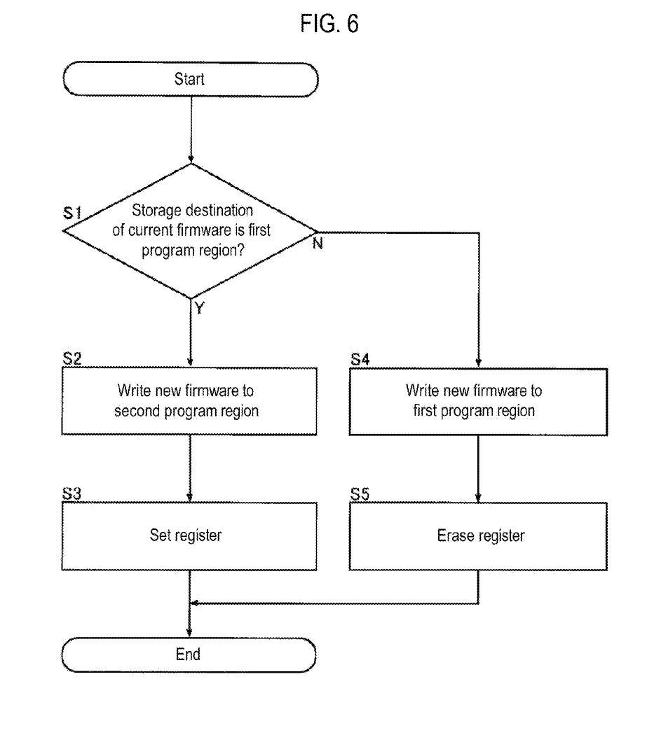

FIG. 6 is a flow chart illustrating a firmware (program) updating process performed by the CPU 11, according to an embodiment of the present disclosure. Initially, it is determined whether a storage destination of firmware of a current version (hereinafter referred to as a “current firmware”) is a first program region A1 of a physical address map in step S1. Herein, when it is determined as YES, the process proceeds to step S2, and when it is determined as NO, the process proceeds to step S4. In addition, information on the storage destination of the current firmware may be stored in the address region A0 of the flash memory 20.

When it is determined as YES in step S1, firmware of a new version (hereinafter referred to as “new firmware”) is written on the second program region A2 of the physical address map in step S2. That is, when the current firmware stored in the flash memory 20 is updated with the new firmware, if the current firmware is stored in the first address region A1, the CPU 11 stores the new firmware in the second address region A2. By this process, even if the process of updating the firmware is interrupted, the current firmware remains in the first address region A1 without being overwritten, and thus, operation of the HD-PLC adapter 1 is not disrupted.

When writing the new firmware is completed in step S2, the first register value REG1 and the second register value REG2 are updated according to the storage destination of the new firmware in the next step S3, and the process is then terminated. Herein, since the storage destination of the new firmware is the second address region A2, a starting address of the first address region A1 is written as the first register value REG1, and a size of the current firmware stored in the first address region A1 or a starting address of the second address region A2 is written as the second register value REG2. By performing such register process, the flash controller 13 performs the foregoing address conversion process to thereby allow the CPU 11 to access the first address region A1, read the new firmware stored in the second address region A2, and execute the new firmware.

Meanwhile, when it is determined as NO in step S1, the new firmware is written on the first program region A1 of the physical address map in step S4. That is, when the current firmware stored in the flash memory 20 is updated with the new firmware, the CPU 11 stores the new firmware in the first address region A1 if the current firmware is stored in the second address region A2. By this process, even if the process of updating the firmware is interrupted, the current firmware remains in the second address region A2 without being overwritten, and thus, operation of the HD-PLC adapter 1 is not disrupted.

When writing the new firmware is completed in step S4, the first register value REG1 and the second register value REG2 are updated based on a storage destination of the new firmware in the next step S5, and the process is then terminated. Herein, since the storage destination of the new firmware is the first address region A1, null values are written as the first register value REG1 and the second register value REG2. By performing such register process, the flash controller 13 does not perform the foregoing address conversion process, and thus, the CPU 11 may access the first address region A1, read the new firmware stored in the first address region A1, and execute the new firmware.

### Other Modified Embodiments

Although the above embodiments describe the present disclosure as being applied to the flash controller 13 of the HD-PLC adapter 1, it is not limited thereto but may be widely applied to any other memory control circuits provided for different purposes.

According to the present disclosure, it is possible to provide a memory control circuit where a compile environment does not need to be changed even when a storage destination of a program is changed.

For example, the present disclosure can be applied to an HD-PLC adapter, etc.

While certain embodiments have been described, these embodiments have been presented by way of example only, and are not intended to limit the scope of the disclosures. Indeed, the novel methods and apparatuses described herein may be embodied in a variety of other forms; furthermore, various omissions, substitutions and changes in the form of the embodiments described herein may be made without departing from the spirit of the disclosures. The accompanying claims and their equivalents are intended to cover such forms or modifications as would fall within the scope and spirit of the disclosures.

What is claimed is:

1. A memory control circuit, comprising
an address conversion unit configured to perform an address conversion between a central processing unit (CPU) and a non-volatile memory such that the CPU recognizes that a program to be executed by the CPU is stored in a first address region of the non-volatile memory irrespective of whether the program is stored in the first address region or a second address region of the non-volatile memory.

2. The memory control circuit of claim 1, further comprising:
a register unit configured to store register values,
wherein the address conversion unit is configured to determine whether to perform an address conversion based on the register values.

3. The memory control circuit of claim 2, wherein the register unit is configured to store, as the register values, a first register value for setting a starting address of the first address region, and a second register value for setting a size of a program stored in the first address region or a starting address of the second address regions.

4. The memory control circuit of claim 2, wherein when the CPU accesses the first address region,
the address conversion unit reads the program stored in the first address region without performing an address conversion if the register values have not been set, and
the address conversion unit performs an address conversion to read the program stored in the second address region if the register values have been completely set.

5. A semiconductor device, comprising:
a CPU; and
the memory control circuit of claim 2 configured to control access to a non-volatile memory based on an instruction from the CPU,
wherein the CPU and the memory control circuit are integrated.

6. The semiconductor device of claim 5, wherein when a current program stored in the non-volatile memory is updated with a new program,
the CPU stores the new program in the second address region if the current program is stored in the first address region, and
the CPU stores the new program in the first address region if the current program is stored in the second address region.

7. The semiconductor device of claim 6, wherein after storing the new program, the CPU updates the register values based on a storage destination of the new program.

8. The semiconductor device of claim 5, further comprising:
a volatile memory configured to be used as an operation region of the CPU or a temporary storage region of various data;
a digital signal processing circuit configured to process a digital signal based on an instruction from the CPU;
a digital-to-analog (DA) conversion circuit configured to convert the digital signal input from the digital signal processing circuit into an analog signal and output the analog signal to an external device; and
an analog-to-digital (AD) conversion circuit configured to convert an analog signal input from the external device into a digital signal and output the digital signal to the digital signal processing circuit,
wherein the volatile memory, the digital signal processing circuit, the DA conversion circuit, and the AD conversion circuit are integrated.

9. A power line communication device, comprising:
the semiconductor device of claim 8;
a non-volatile memory configured to be access-controlled by the semiconductor device; and
a transformer configured to insulate between the semiconductor device and a power line and deliver analog signals.

10. The semiconductor device of claim 9, wherein the non-volatile memory is a serial flash memory.
